(19) United States
(12) Patent Application Publication
(10) Pub. No.: US 2013/0257879 A1
(43) Pub. Date: Oct. 3, 2013

(54) GEOLOGICAL ANIMATION

(71) Applicant: SCHLUMBERGER TECHNOLOGY CORPORATION, (US)

(72) Inventor: Bernd Kurtenbach, Nettetal (DE)

(73) Assignee: SCHLUMBERGER TECHNOLOGY CORPORATION, Sugar Land, TX (US)

(21) Appl. No.: 13/732,340

(22) Filed: Dec. 31, 2012

Related U.S. Application Data
(60) Provisional application No. 61/619,779, filed on Apr. 3, 2012.

(51) Int. Cl. G06T 13/00

(52) U.S. Cl. CPC G06T 13/00
USPC 345/475

(57) ABSTRACT

An example embodiment of the present disclosure may include one or more of a method, computing device, computer-readable medium, and system for animating geology. An example embodiment of a method may include providing a geological model that includes a first object and a second object, wherein the first and second objects comprise geological data relating to a first and second geological time respectively. The method may also include interpolating a property value of the first object and a property value of the second object to produce an interpolated property value. The representation of the interpolated property value may be output along with an animation that comprises the representation of the interpolated property value.

### CROSS-REFERENCE TO RELATED APPLICATION

This application claims the benefit of (a) U.S. Provisional Patent Application 61/619,779 filed Apr. 3, 2012 entitled “4D Geology Animation,” the disclosure which is hereby incorporated in its entirety.

### BACKGROUND

The graphical user interface (GUI) of a video tool may include functionality to allow snapshots taken from an animation to be displayed on a storyboard. This could include a tool for composing one or more video clips in order to be rendered into a video. Certain animation movie tools may provide automated graphical interpolation between snapshots (sometimes referred to as “tweening”). Tweening is a graphical interpolation technique where an animation program generates extra frames between the key frames that the user has created. This can produce an animation that doesn't involve the user drawing every frame of the animation.

A scene can be described by a mathematical model—e.g., a set of one or more two- or three-dimensional objects whose positions are described by one or more coordinates. Tweening can use mathematical formulae to generate these coordinates at a sequence of discrete times.

Geological models may be employed to assist with resource assessment and recovery. A geological modeling process may include acquisition of seismic data for a geological site and analysis of the seismic data to construct a model of the site. Given a model, an engineer may make assessments as to a subterranean resource at the site and may generate model-based simulation data that sheds light on potential recovery of the resource from the site.

There is a need to for creating, editing, and/or viewing an animation related to a geological model using geological interpolation, graphical interpolation, and/or other techniques. Embodiments to address this need are set forth in the present disclosure.

### SUMMARY

An embodiment of the present disclosure may include one or more of a method, computing device, computer-readable medium, and system performing animation in the context of geological simulation data and/or geo-science presentation workflows. An example embodiment of a method may include providing a geological model that includes a first object and a second object. The first and second objects include geological data relating to a first and second geological time respectively. The method may also include interpolating a property value of the first object and a property value of the second object to produce an interpolated property value. The representation of the interpolated property value may be output along with an animation that includes the representation of the interpolated property value.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Implementations of various technologies will hereafter be described with reference to the accompanying drawings. It should be understood, however, that the accompanying drawings illustrate the various implementations described herein and are not meant to limit the scope of various technologies described herein.

FIG. 1 illustrates a system that includes various components for simulating a geologic environment according to an example embodiment of the present disclosure.

FIG. 2 illustrates example modules according to an example embodiment of the present disclosure.

FIG. 3 illustrates an example user interface according to an example embodiment of the present disclosure.

FIG. 4 illustrates a chart of model and rendering properties according to an example embodiment of the present disclosure.

FIG. 5 is a method according to an example embodiment of the present disclosure.

FIG. 6 illustrates a computer system that may embody an implementation of various technologies and techniques described herein according to an example embodiment of the present disclosure.

### DETAILED DESCRIPTION

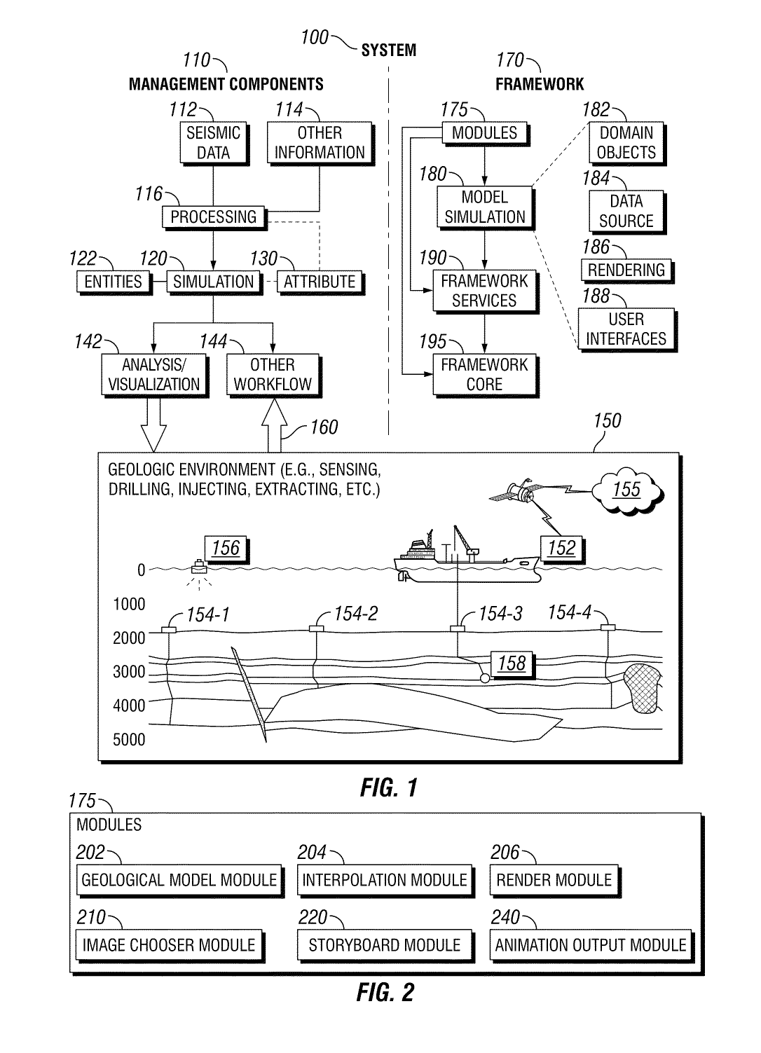

FIG. 1 shows an example of a system 100 that includes various management components 110 to manage various aspects of a geologic environment 150 (e.g., an environment that includes a sedimentary basin) as well as an example of a framework 170. In the example of FIG. 1, the components may be or include one or more modules. As to the management components 110, one or more of these components may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, reservoirs, geobodies, etc. In the system 100, the entities 122 can include virtual representations of actual physical entities that are reconstructed for purposes of simulation. The entities 122 may include entities based on data acquired via sensing, observation, interpretation, etc. (e.g., the seismic data 112 and other information 114).

In an example embodiment, the simulation component 120 may rely on a software framework such as an object-based framework. In such a framework, entities may include entities based on pre-defined classes to facilitate modeling and simulation. A commercially available example of an object-based framework is the MICROSOFT® .NET™ framework (Redmond, Wash.), which provides a set of extensible object classes. In the .NET™ framework, an object class encapsulates a module of reusable code and associated data structures. Object classes can be used to instantiate object instances for use in by a program, script, etc. For example, borehole classes may define objects for representing boreholes based on well data, geobody classes may define objects for representing geobodies based on seismic data, etc. As an example, an interpretation process that includes generation of one or more seismic attributes may provide for definition of a geobody using one or more classes. Such a process may occur via interaction (e.g., user interaction), semi-automatically or automatically (e.g., via a feature extraction process based at least in part on one or more seismic attributes).

In the example of FIG. 1, the simulation component 120 may process information to conform to one or more attributes specified by the attribute component 130, which may include a library of attributes. Such processing may occur prior to input to the simulation component 120. Alternatively, or in addition, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results, attributes, etc. In an example embodiment, output from the simulation component 120, the attribute component 130 or one or more other components may be input to one or more other workflows, as indicated by a workflow component 144 (e.g., for triggering another process).

In an example embodiment, the management components 110 may include features of a commercially available simulation framework such as the PETREL® seismic to simulation software framework. The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of simulating a geologic environment).

In an example embodiment, various aspects of the management components 110 may include add-ons or plug-ins that operate according to specifications of a framework environment. For example, a commercially available framework environment marketed as the OCEAN® framework environment (Schlumberger Limited, Houston, Tex.) allows for seamless integration of add-ons (or plug-ins) into a PETREL® framework workflow. The OCEAN® framework environment leverages .NET® tools (Microsoft Corporation, Redmond, Wash.) and offers stable, user-friendly interfaces for efficient development. In an example embodiment, various components (e.g., or modules) may be implemented as add-ons (or plug-ins) that conform to and operate according to specifications of a framework environment (e.g., according to application programming interface (API) specifications, etc.).

FIG. 1 also shows, as an example, the framework 170, which includes a model simulation layer 180 along with a framework services layer 190, a framework core layer 195 and a modules layer 175. The framework 170 may include the commercially available OCEAN® framework where the model simulation layer 180 is the commercially available PETREL® model-centric software package that hosts OCEAN® framework applications. In an example embodiment, the PETREL® software may be considered a data-driven application. The PETREL® software can include a framework for model building and visualization. Such a model may include one or more grids (e.g., that represent a geologic environment).

The model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for application user interface components.

In the example of FIG. 1, the domain objects 182 can include entity objects, property objects and optionally other objects. Entity objects may be used to geometrically represent wells, surfaces, reservoirs, geobodies, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project can be accessed and restored using the model simulation layer 180, which can recreate instances of the relevant domain objects.

In the example of FIG. 1, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 158, which may be equipment to drill, acquire information, assist with resource recovery, etc. Other equipment 156 may be located remote from a well site and include sensing, detecting, emitting or other circuitry. Such equipment may include storage and communication circuitry to store and to communicate data, instructions, etc. The geologic environment 150 also shows various wells (e.g., wellbores) 154-1, 154-2, 154-3 and 154-4. In the example of FIG. 1, the downhole equipment 158 may include a drill for drilling the well 154-3.

The framework 170 may provide for modeling the geologic environment 150 including the wells 154-1, 154-2, 154-3 and 154-4 as well as stratigraphic layers, lithologies, faults, etc. The framework 170 may create a model with one or more grids, for example, defined by nodes, where a numerical technique can be applied to relevant equations discretized according to at least one of the one or more grids. As an example, the framework 170 may provide for performing a simulation of phenomena associated with the geologic environment 150 using at least a portion of a grid. As to performing a simulation, such a simulation may include interpolating geological rock types, interpolating petrophysical properties, simulating fluid flow, or other calculations (e.g., or a combination of any of the foregoing).

According to an example embodiment, a system 100 may enable a user to create, edit, and/or view geological animations (e.g., animating geological simulation data). FIG. 2 shows an example embodiment of modules layer 175 (shown in FIG. 1) that includes a geological model module 202. Geological model module 202 may provide a geological model that includes one or more objects that include geological data relating to one or more geological times. Modules layer 175 may also include an interpolation module 204 for performing numerical interpolation calculations and/or graphical interpolation calculations with respect to one or more property values relating to the one or more objects of a geological model. A render module 206 may render or otherwise output one or more aspects of a geological model (e.g., a property value relating to an object of a geological model).

Modules layer 175 may also include an example image chooser module 210. A user may use the image chooser module to view and/or select one or more images. Furthermore, the modules layer 175 may include a storyboard module 220. An example storyboard module may provide certain functionality, including, without limitation, allowing a user to arrange the sequence of one or more images in a storyboard fashion, e.g., as part of producing an animation according to an embodiment of the present disclosure. The example modules layer 175 may also include an animation output module 240 which may provide certain functionality, including, without limitation, rendering an animation that is produced using the animation production module 220.

A geological model can be multidimensional in space (e.g., three-dimensional), correspond to a certain time (e.g., time of seismic data acquisition) and allow for simulations related to resource recovery. An example embodiment of the present disclosure may enable presentation of data that changes through geological time (i.e., time may be represented as a fourth dimension in an animation in addition to one or more spatial aspects). The visualized data may be generated by a simulation of one or more geological processes.

Geological interpolation can be performed along with a graphical interpolation approach (e.g., tweening) to produce a 4D geology animation in a manner described herein. According to an example embodiment, geological interpolation may include using data related to simulation results to produce a geological simulation animation. Geological interpolation may be used instead of, or in addition to, graphical interpolation to create, edit, and/or present an animation related to geological simulation data and/or geo-science workflows (e.g., a presentation workflow).

An example embodiment of the present disclosure may include a process for generating an animation related to a geological model (e.g., 4D animations which represent time in addition other spatial aspects). This can be useful for creating oil and gas exploration management presentations, which may be used, for example, to support one or more oil and gas industry operations (e.g., drilling decisions and/or license round biddings).

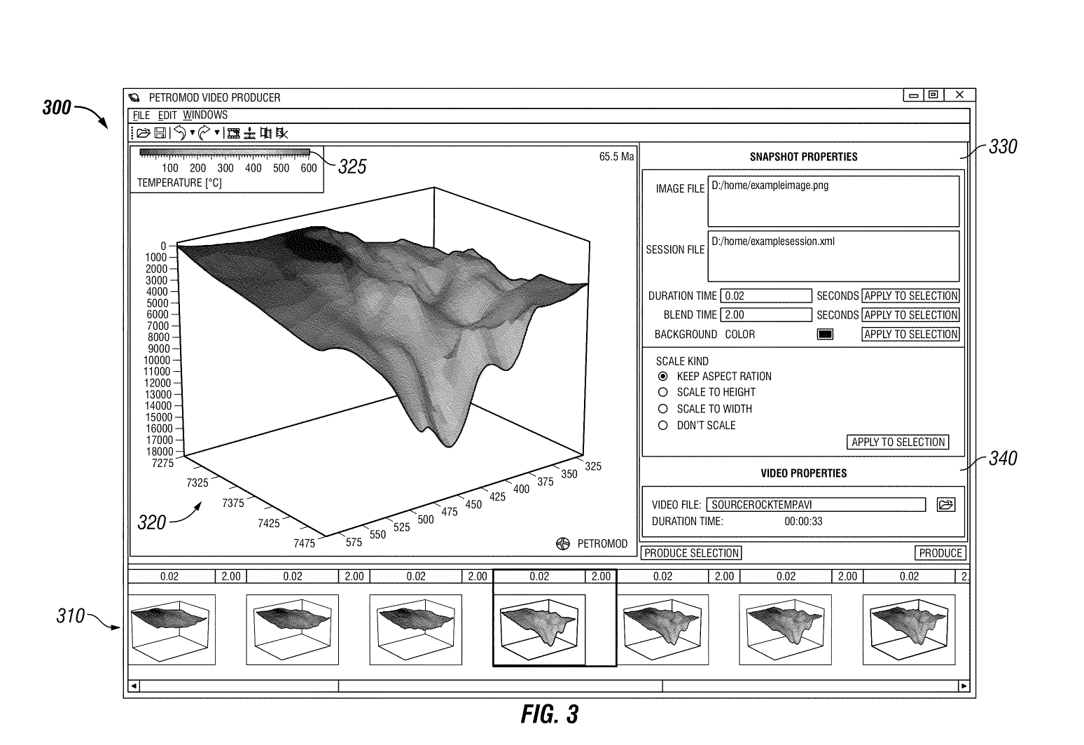

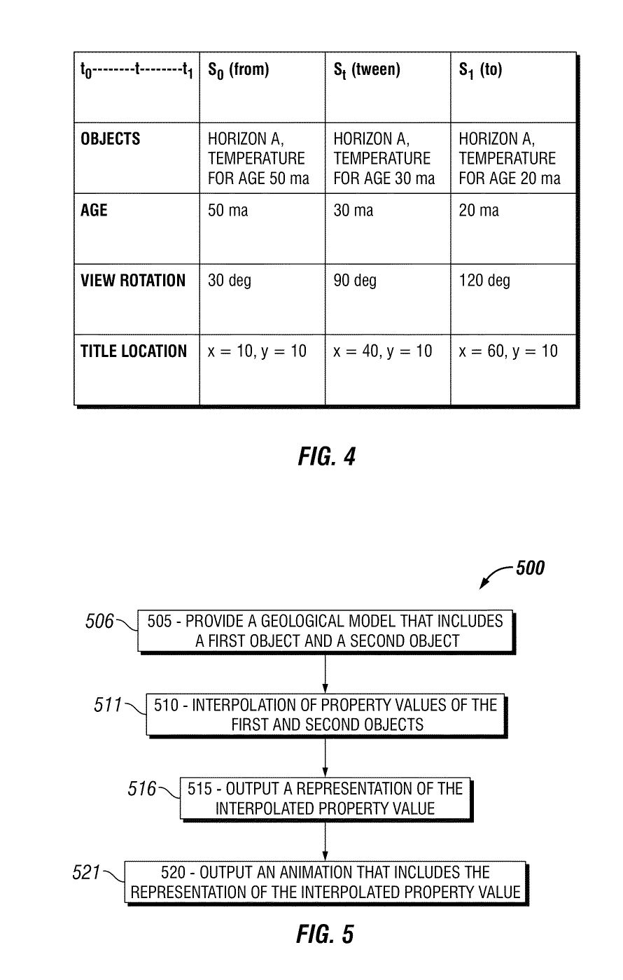

FIG. 3 shows an example user interface (UI) 300 according to an example embodiment of the present disclosure. The UI 300 includes a storyboard UI element 310, an image viewer UI element 320, an age counter UI element 325, an image property UI element 330, and a video properties UI element 340.

The storyboard UI element may be used to arrange a sequence of a plurality of images related to a geological animation. The images may include one or more images (e.g., snapshots or thumbnails) related to a geological model (e.g., a model that provides data that dynamically varies through geological time). An example operation of a storyboard may include enabling a user to arrange a plurality of images (e.g., similar to arranging a plurality of frames related to a movie).

The images shown in a storyboard may be generated based on user input. For example an image chooser UI element may present to a user a plurality of two-dimensional or three-dimensional images related to a geological animation, and the user may choose one or more images to appear in the storyboard.

In an example embodiment, a data structure may maintain a plurality of parameters related to the images. Such parameters may include, without limitation, a list of visible items and their color properties. Parameters may include the geological age of the scene (e.g., specified in million years (ma)). Another example parameter may include a duration that defines how long an interpolation in a geological animation will last. Yet another example parameter may enable a user to specify a duration for keeping an image unchanged. For example, the duration for keeping a snapshot unchanged may range from approximately 0.02 seconds to approximately 2.00 (these are just example durations, and other durations are within the scope of the present disclosure).

The image viewer UI element may be used to display one or more results related to a simulation event. According to an example embodiment, an image viewer may show a more detailed and/or enlarged version of a selected image (e.g., an image that is chosen by a user in the storyboard UI element to be the “current” image).

The image property UI element may display information about a selected image (e.g., the current image displayed in the image viewer UI element) and/or information about the current session. Such information may include, without limitation, an image filename, a session file name, duration time, blend time, background color, and/or scale type (e.g., keep aspect ratio, scale to height, scale to width, don't scale). The image property UI element may be used to modify one or more of properties of the image shown in an image viewer UI element.

The image property UI element may include an age counter UI element that displays a geological age related to an animation. An example age counter may display the age of a frame during the animation (e.g., the current frame). It can be visualized as a number in million years (ma) or as a slider that moves on a time scale showing the regional chrono-stratigraphy.

The video properties UI element may display information about a video file that includes a geological animation. Such information may include, without limitation, a video file name, a duration time, and/or any other information about the video file.

A numerical simulation through geological time can produce a relatively large amount of output data. The resolution of this data may be relatively limited in 3D space and a 4^{th} dimension (e.g., geological time). Data through time may be given as a series of 3D output models created by a simulator, wherein a model may be related to a particular time period in geological history (e.g., this may be referred to as “an event”). The number of events can relate to the total data amount, and might be set in an order of magnitude of any number of steps (e.g., about 10-100 steps). However, in certain situations, this might not be enough steps to generate a relatively smooth animation of simulation results. Additional computing may be involved to generate a smoother animation.

An example embodiment of the present disclosure can output a video based on one or more images in the storyboard UI element (e.g., render the video). This may be done frame by frame, by performing graphical and/or geological interpolation based on the images in the storyboard UI element. The resulting video can later be used for other purposes (e.g., for a presentation).

Depending on hardware and algorithm speed, real-time rendering with no video file generated may be possible.

### Interpolating

According to an example method, upon composing a storyboard, a user may render at least a portion of an animation (e.g., this may be enabled by the animation rendering module 240 described in FIG. 2). In an example embodiment, an example rendering process might not take into consideration one or more images that are arranged using a storyboard. That is, each frame of the resulting animation could be generated using only geological interpolation (e.g., by only accessing simulation data).

Another example rendering process might use one or more images arranged with the storyboard. Such a rendering process might include interpolating frame t between a plurality of images. As an example, at least three versions of a geological model may be maintained in memory according to the following example method:

1. Version S₀ (from) of a geological model, wherein S₀ includes one or more settings according to image t₀ (wherein image t₀ is an image before image t according to a storyboard arrangement—e.g., the image that immediately precedes image t).

2. Version S₁ (to) of a geological model, wherein S₁ includes one or more settings according to image t₁ (wherein image t₁ is an image after image t according to a storyboard arrangement—e.g., the image that immediately follows image t).

3. Version Sₜ of a geological model, wherein Sₜ includes one or more settings interpolated for t₀<t<t₁. An example embodiment might not be represent Sₜ on a storyboard.

FIG. 5 shows a chart that describes at least a portion of an example animation. The portion of the example animation described in FIG. 5 may show the same geological horizon from different directions. During the animation, the view rotation angle and/or an animation title can move around the scene. These kinds of visualization parameters may be interpolated as shown here for Sₜ.

In contrast to this approach, age-related effects can exhibit more complex behavior. While the age parameter itself may be interpolated like any other view parameter, the impact on the geological objects may be considered and visualized according to simulation results. In this example, horizon A shows a different geometry for each frame of the animation, although these geometries might not be produced as part of a simulator's output. Also the temperature, which may be displayed as a colored overlay on the horizon surface, can vary all through the animation.

When an interpolation for a geological object is computed, a simple mathematical approach might not lead to geologically reasonable results. Certain post-processing algorithms known in the art can be applied instead (such post-processing algorithms are not discussed herein).

As shown by the “Objects” row in FIG. 5, a visualization of a geological object can vary to reflect one or more variables (e.g., geometry and/or temperature) related to a Horizon for a certain geological age. Accordingly, using the age parameter, geo-time dynamical processes may be presented in a way that may not be possible with certain other animation software.

Example embodiments of the present disclosure, unlike certain other animation software, may include geo-science processing. Frame by frame, the time t may be calculated according to the progress of the rendering process. Version Sₜ may be rendered for each frame. This may be done using a graphics frame buffer. The rendered frame might only exist temporarily. This may include the interpolated data of version Sₜ. This can consume a relatively large amount of memory, however at least a portion of the memory allocated for version Sₜ (e.g., all memory allocated for version Sₜ) can be freed after the resulting frame is written to the video stream and before the next t is calculated.

### Example Geological Interpolation Cases

1. View context data: View settings, such as view angle, background or annotation color, zoom factor may be linearly interpolated. If a setting changes that is a switch, it may be switched at t=0, t=0.5 or t=1.0, depending on the meaning of that switch.

2. Gridded geometry data with vertical variation: Certain geological processes may happen along the depth axes: e.g. deposition, erosion and compaction. The representation of this data may be specified on a grid that is fixed in x and y, but variable in the z direction. In this case every single z value may be interpolated linearly.

3. Geometry data that varies in a horizontal direction:

a. Displacement: When rigid matter migrates from cell to cell in a grid, this can be modeled as facies switches: e.g. salt movement. In this case, numerical interpolation of facies IDs might not make sense. Solutions like varying salt content or spatial subdivision of a volume cell could involve a relatively high effort. In an example, a simple t=0.5 switch can serve well for visualization purposes.

b. Migration: Fluids migrate through pore space. Therefore they do not have to displace any matter. The shape of accumulations and pathways may depend on the seal horizon geometries that are interpolated for the same animation as well. When the same vertical method is applied to the accumulations that are also used for the horizons, matching geometries may be generated in the sense of fitting into the model without seal intersections. Special cases, such as sealing faults or salt domes, may be considered.

A potential disadvantage of this approach may be that an accumulation that covers area₁ in the beginning of an animation step and areaₑ at the end, may cover the whole united area_{1,2} during the animation. In a top down view it might first stretch rapidly and later shrink again. This could be addressed by a mini-flowpath simulation that fills the migrating fluid volume into the interpolated seal geometry for each frame.

A geological simulation may include flowpath analysis. The flowpath analysis may be complex. For animation purposes it may need to be simplified. In an example embodiment, no fluid should leave area_{1,2} during the animation.

4. Physical properties: Physical properties like temperature or porosity are numerical values that may be displayed by colored overlays. This kind of data can be interpolated linearly. The same can apply to properties that are not given on the grid itself, like mass balances or petroleum compositions. Linear interpolation should provide consistent results in these cases. Special cases include properties that are given as switch states (e.g. fault open/closed) or enumerables (e.g. hydrocarbon zones).

### Presentation

A geological model animation produced in according with the present disclosure may be written to a video file on a computing device. The video file may be written to the video file using any method known in the art (e.g. .avi files on Windows). The resulting video can be presented in media player tools or integrated into office presentations.

The original data that was used for the rendering process might not be present during the presentation. The performance of the rendering process can vary depending on data size.

Certain technology that is used to generate an animation of the present disclosure may be called “Basin Modeling” or “Petroleum Systems Modeling.” “4D Geological Animations” according to the present disclosure could also be applied to other packages, such as “Structural Reconstruction” or “Pressure Prediction.”

An example embodiment of the present disclosure may be considered in the context of U.S. patent application Ser. No. 13/271,984, filed Oct. 12, 2011, titled “Representing Geological Objects Specified Through Time In A Spatial Geology Modeling Framework.” The disclosure of U.S. patent application Ser. No. 13/271,984 is hereby incorporated in its entirety. U.S. patent application Ser. No. 13/271,984 described a “Geo-Time Slider” that connects the “Geo-Time Window” (plotting data through geological time) with a 2D, 3D or map window that displays “Geo-Time Playable Objects” according to an age that is specified by the slider.

Similar to the animations in the present disclosure, the problem of missing data between the dedicated simulator output events can be addressed for the “Geo-Time Playable Objects” of the aforementioned patent application as well. Actual animation algorithms could be shared for both purposes.

As described in U.S. patent application Ser. No. 13/271,984, in an example embodiment, one or more computer-readable media (CRM) can include computer-executable instructions to instruct a computing system to: instantiate a geological time object configured to provide a geological time axis; link property data of a geological model to geological times of the geological time axis of the instantiated geological time object; and structure the linked property data with respect to the geological time axis in a screen renderable format. For example, the CRM may provide instructions for instantiating a geological time object, the CRM may provide instructions for linking property data of a geological model to geological times of the geological time axis of the instantiated geological time object, and the CRM may provide instructions to structure the linked property data with respect to the geological time axis in a screen renderable format. In an example embodiment, computer-executable instructions may be provided to instruct a computing system to exchange data between an object of a geological model and a geological time object, which may optionally occur during a simulation or other computing process.

Understanding the dynamics of the earth's evolution in a geological sense can contribute to successful exploration of oil and gas fields. Geological processes like oil and gas generation, migration and accumulation can be simulated. Certain graphical presentations in the exploration business show 2D graphics. Some are 3D, but nonetheless, the dimensions are spatial, and dynamic processes are not visualized.

FIG. 5 shows a flow chart illustrating an example method 500 according to the present disclosure in association with various computer-readable media (CRM) blocks 506, 511, 516, 521. Such blocks generally include instructions suitable for execution by one or more processors (or processor cores) to instruct a computing device or system to perform one or more actions. While various blocks are shown, a single medium may be configured with instructions to allow for, at least in part, performance of various actions of the method 500. As an example, a computer-readable medium (CRM) may be a computer-readable storage medium.

Method 500 may include a block 505 that provides a geological model. The geological model may include a first object and a second object. The first and second objects may include geological data relating to a first and second geological time respectively. In an example embodiment, the geological model may include a geological time data structure configured to link the first object to the first geological time. The first object may be linked to the first geological time and simulation results for the geological model may be generated. Based at least in part on the geological time data structure, method 500 may include outputting at least some of the simulation results along a geological time axis.

Block 510 may include interpolation of property values of the first and second objects to produce interpolated values. In an example embodiment, interpolating may include performing a plurality of simulations using the geological model, and using the results of the simulations as input to the interpolating. Interpolation may include performing a graphical interpolation of the representations of the property values of the first and second objects.

Block 515 may include outputting a representation of the interpolated property value. At least one of the graphical interpolation and/or the representation of the property values of the first and second objects may be output as a graphical user interface (e.g., as one or more thumbnail images in a “storyboard” user interface element).

Block 520 may include outputting an animation that includes at least one of the representation of the interpolated property value, the representation of the property value of the first object, and the representation of the property value of the second object.

### Computer System

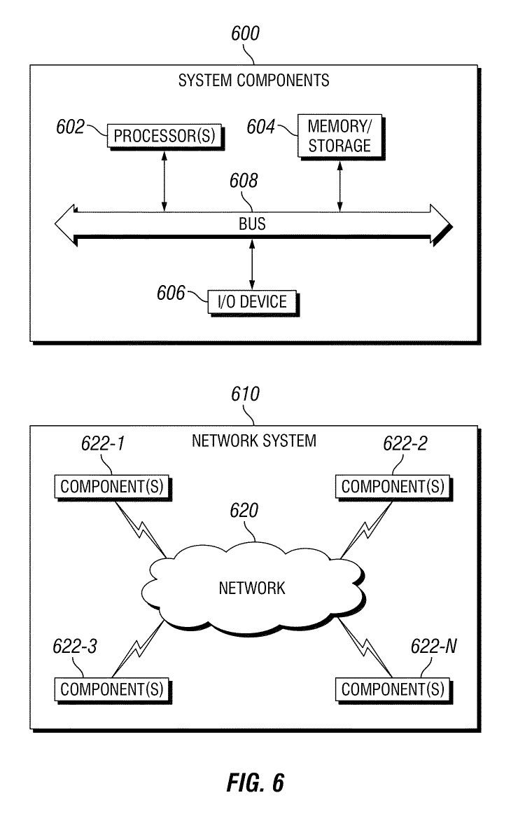

FIG. 6 shows components of an example of a computing system 600 and an example of a networked system 610. The system 600 includes one or more processors 602, memory and/or storage components 604, one or more input and/or output devices 606 and a bus 608. In an example embodiment, instructions may be stored in one or more computer-readable media (e.g., memory/storage components 604). Such instructions may be read by one or more processors (e.g., the processor(s) 602) via a communication bus (e.g., the bus 608), which may be wired or wireless. The one or more processors may execute such instructions to implement (wholly or in part) one or more attributes (e.g., as part of a method). A user may view output from and interact with a process via an I/O device (e.g., the device 606). In an example embodiment, a computer-readable medium may be a storage component such as a physical memory storage device, for example, a chip, a chip on a package, a memory card, etc. (e.g., a computer-readable storage medium).

In an example embodiment, components may be distributed, such as in the network system 610. The network system 610 includes components 622-1, 622-2, 622-3, . . . 622-N. For example, the components 622-1 may include the processor(s) 602 while the component(s) 622-3 may include memory accessible by the processor(s) 602. Further, the component(s) 602-2 may include an I/O device for display and optionally interaction with a method. The network may be or include the Internet, an intranet, a cellular network, a satellite network, etc.

### Conclusion

Although only a few example embodiments have been described in detail above, those skilled in the art will readily appreciate that many modifications are possible in the example embodiments. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112, paragraph 6 for any limitations of any of the claims herein, except for those in which the claim expressly uses the words “means for” together with an associated function.

What is claimed is:

1. A method of generating a geological animation, comprising:
providing a geological model comprising a first object and a second object, wherein the first and second objects comprise geological data relating to a first and second geological time respectively;
interpolating a property value of the first object and a property value of the second object to produce an interpolated property value;
outputting a representation of the interpolated property value; and
outputting an animation that comprises the representation of the interpolated property value.

2. The method of claim 1, wherein the animation further comprises at least one of a representation of a property value of the first object and a representation of a property value of the second object.

3. The method of claim 2, further comprising:
performing a graphical interpolation of the representations of the property values of first and second objects;
outputting the graphical interpolation.

4. The method of claim 2, further comprising arranging a display order of the first and second representations using a graphical user interface.

5. The method of claim 1, wherein the interpolating further comprises performing a plurality of simulations using the geological model, and using the results of the simulations as input to the interpolating.

6. The method of claim 1, wherein the interpolating further comprises interpolation of data chosen from a group consisting of: view context data, gridded geometry data with vertical variation, geometry data that varies in a horizontal direction, and a physical property.

7. The method of claim 1, wherein the geological data is represented on a grid that is variable along an axis, and at least one of the property value of the first or second object comprises a value along the axis.

8. The method of claim 1, wherein providing the geological model comprises:
providing a geological time data structure configured to link the first object to the first geological time;
linking the first object to the first geological time;
generating simulation results for the geological model; and
based at least in part on the geological time data structure, outputting at least some of the simulation results along a geological time axis.

9. One or more computer-readable storage media comprising computer-executable instructions to instruct a computing system to:
provide a geological model comprising a first object and a second object, wherein the first and second objects comprise geological data relating to a first and second geological time respectively;
interpolate a property value of the first object and a property value of the second object to produce an interpolated property value;
output a representation of the interpolated property value; and
output an animation that comprises at least one of the representation of the interpolated property value, a representation of a property value of the first object, and
a representation of a property value of the second object.

10. The one or more computer-readable storage media of claim 9, further comprising instructions to:
perform a graphical interpolation of the representations of the property values of first and second objects, and wherein the animation comprises the graphical interpolation.

11. The one or more computer-readable storage media of claim 9, further comprising instructions to arrange a display order of the first and second representations.

12. The one or more computer-readable storage media of claim 9, further comprising instructions to perform a plurality of simulations using the geological model, and using the results of the simulations as input to the interpolating.

13. The one or more computer-readable storage media of claim 9, further comprising instructions to represent the geological data on a grid that is variable along an axis, and wherein at least one of the property value of the first or second object comprises a value along the axis.

14. The one or more computer-readable storage media of claim 9, wherein the instructions to provide the geological model cause the computing system to:
provide a geological time data structure configured to link the first object to the first geological time;
link the first object to the first geological time;
generate simulation results for the geological model; and
based at least in part on the geological time data structure, output at least some of the simulation results along a geological time axis.

15. A system comprising:
one or more processors for processing information;
memory operatively coupled to the one or more processors; and
modules that comprise instructions stored in the memory and executable by at least one of the one or more processors, wherein the modules comprise:
a geological model module for providing a geological model comprising a first object and a second object, wherein the first and second objects comprise geological data relating to a first and second geological time respectively;
an interpolation module for interpolating a property value of the first object and a property value of the second object to produce an interpolated property value;
a render module for outputting a representation of the interpolated property value; and
an animation output module for outputting an animation that comprises at least one of the representation of the interpolated property value, a representation of a property value of the first object, and a representation of a property value of the second object.

16. The system of claim 15, further comprising a graphical interpolation module for performing a graphical interpolation of the representations of the property values of first and second objects.

17. The system of claim 15, further comprising a storyboard module for arranging a display order of the first and second representations using a graphical user interface.

18. The system of claim 15, wherein the interpolation module performs a plurality of simulations using the geological model, and uses the results of the simulations as input to the interpolating.

19. The system of claim 15, wherein the interpolation module performs an interpolation of data chosen from a group consisting of: view context data, gridded geometry data with vertical variation, geometry data that varies in a horizontal direction, and a physical property.

20. The system of claim 15, wherein the geological model comprises a geological time data structure configured to link the first object to the first geological time, and a link between the first object and the first geological time; and the geological model module further generates simulation results for the geological model; and based at least in part on the geological time data structure, outputs at least some of the simulation results along a geological time axis.
